(19) United States
(12) Patent Application Publication
(10) Pub. No.: US 2005/0159262 A1
(43) Pub. Date: Jul. 21, 2005

(54) Timing belt with wave glide surface

(75) Inventor: Rudolph Schoendienst, Brick, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: BrecoFlex Co., L.L.C., Eatontown, NJ (US)

(21) Appl. No.: 10/762,176

(22) Filed: Jan. 21, 2004

(51) Int. Cl. F16G 1/00; F16G 1/28; F16G 5/20

(52) U.S. Cl. 474/237; 474/238; 474/265; 474/252; 474/251

(57) ABSTRACT

A timing belt comprising a wave glide surface having a side view substantially similar to a sinusoidal curve. The wave glide surface of the belt is provided for adjusting the coefficient of friction between the belt and a slider bed which is used for providing structure and integrity to the belt. Additionally, reservoirs and channels may be provided on the wave glide surface so as to house and disburse an agent thus enabling further increasing or decreasing of the coefficient of friction between the belt and the slider bed. To provide lateral guidance of the belt, a tracking guide may be provided so as to engage grooves on the periphery of pulleys. Furthermore, a plurality of teeth may be provided on the belt so as to aid in a multiple of functions during operation of the belt.

### BACKGROUND OF THE INVENTION

The present invention relates generally to timing belts for use with belt drive systems.

It is known in the art to provide a timing belt with a tracking system so as to prevent lateral movement of the timing belt as it rotates about its axis points usually provided by two opposing pulleys or as it alternates bi-directional as with a linear drive system, or the like. The tracking system may be in the form of a guide directly linked to the belt. Alternately, the tracking system may be formed in conjunction with components of the belt drive systems, such as with the pulleys. Examples of tracking guides are disclosed in commonly-assigned U.S. Pat. Nos. 5,006,096 and 5,013,286, the disclosures of which are incorporated herein by reference.

Timing belts in conjunction with belt drive systems may be used to perform a myriad of operations. As for example, timing belts can be used for propelling a vehicle forward or moving product along a conveyor belt. However, if the belt is composed of a flexible plastic as compared to solid plates linked together, a support member may have to be included which incorporates with the belt so as to provide structure and integrity to the system. This support member provides a reactionary force against the belt when the belt functions to propel a vehicle forward along the ground. Additionally, if the belt is used to move product back and forth a drive system, the belt must be sufficiently supported so as to be able to withstand the weight of the product in a downward direction and still laterally move the product along the belt. An example of such a support system is when a slider bed is placed under the timing belt in the case where product is being moved by the timing belt, or the slider bed is placed over the timing belt when the timing belt is being used to propel a vehicle forward. This slider bed provides the reactionary force the timing belt needs against either the product or the ground.

Still, because the addition of a slider bed adds a new element which adds structural energy losses, what is needed in the art is better cooperation between the timing belt and the slider bed so as to minimize the structural losses.

Additionally, what is needed is the ability to manipulate the coefficient of friction, either increasing or decreasing, depending on the function to be performed.

### SUMMARY OF THE INVENTION

The timing belt of the present invention is characterized primarily in that a wave glide surface is provided extending in a longitudinal direction of the belt. The wave glide surface has a cross-sectional side view substantially similar to a sinusoidal curve and includes an apex portion and a base portion. The main function of the wave glide surface of the belt is to allow manipulation of the coefficient of friction between the belt and a slider bed. This manipulation of the coefficient of friction is possible due to the fact that during operation of the belt, only the apex portions of the wave glide surface come in contact with the slider bed. Thus, depending on the amount of apex portions, i.e., the angles of the sinusoidal curves, the coefficient of friction may be increased or reduced. In a variant of the present application, the belt may have a substantially flat surface in contact with the slider. However, in this alternate embodiment, the slider bed may be provided with a side view similar to a sinusoidal curve. Thus, a reduced number of contact points between the slider bed and the wave glide surface are maintained. Teeth may be provided on the timing belt wherein the teeth include a plurality of tooth ribs and tooth grooves. The teeth may extend the entire side-to-side lateral length of the belt of the teeth may only extend a portion of the side-to-side lateral length of the belt. Furthermore, the teeth may be included on the same side as the wave glide surface of the belt or on an opposing side of the belt as compared with the wave glide surface.

The present invention further contemplates manipulating the coefficient of friction between the belt and a slider bed by providing channels with either the wave glide surface or the slider bed. The channels are designed to house and disperse an agent across the wave glide surface and slider bed and thus, along contact points between the wave glide surface and the slider bed. The channels may be randomly distributed along the wave glide surface or may be distributed along a specific geometric curve. This curve may be a straight line in the longitudinal direction of the belt, may be a sinusoidal curve along the top of the wave glide surface and further may even be a spiral curve along the surface of the wave glide surface.

The present invention may further be altered in that a tracking guide may be provided with the belt so as to provide lateral guidance of the belt as it rotates about a pulley system. The tracking guides may be placed at various locations on the belt including adjacent to the wave glide surface or on opposing surface of the belt as compared to the wave glide surface. Additionally, teeth may be incorporated with the tracking guide in order to increase lateral stability of the belt. The tracking guide may have a height greater, equal to or less than the apex portions of the wave glide surface.

In preferred embodiments of the present invention, the apex portion of the sinusoidal curve of the wave glide surface may be placed directly adjacent to the tooth grooves while the base portions are placed directly adjacent to the tooth ribs. This provides a somewhat constant thickness of the belt.

### BRIEF DESCRIPTION OF THE DRAWINGS

This object, and other objects and advantages of the present invention, will appear more clearly from the following specification in conjunction with the accompanying schematic drawings.

FIG. 1 shows a first embodiment of the present invention rotating around a pulley system;

FIG. 2 shows a portion of the first embodiment of the present invention of the timing belt;

FIG. 3 shows a side view of the first embodiment of the present invention;

FIG. 4 shows a cross-sectional view of the first embodiment of the present invention;

FIG. 5 shows a three dimensional cross-sectional view of a second embodiment of the present invention;

FIG. 6 shows three dimensional a cross-sectional view of a third embodiment of the present invention; and

FIG. 7 shows a three dimensional cross-sectional view of a fourth embodiment of the present invention;

FIG. 8 shows a perspective view of a fifth embodiment of the present invention;

FIG. 9 shows a perspective view of a sixth embodiment of the present invention.

### DETAILED DESCRIPTION

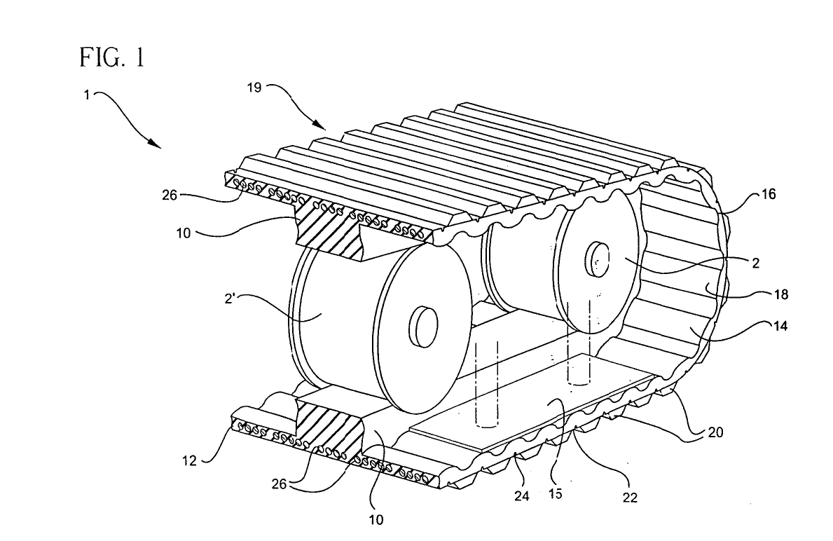

Generally referring to FIGS. 1-4, belt 1 is made of plastic or similar extrudable material. The belt is provided with tracking guide along a longitudinal line that extends along the center of the belt. Tracking guide 10 is formed along with the belt in a belt manufacturing process from the same material; in other words, rib 10 is a component of belt 1 that is injected, extruded or machined directly onto belt body 12 during the manufacturing of the belt. Tracking guide 10 facilitates the movement of the belt 1 along a constant longitudinal axis by preventing belt 1 from laterally leaving pulleys 2 and 2′. By means of tracking guide 10, the timing belt is automatically guided on the correspondingly constructed pulleys.

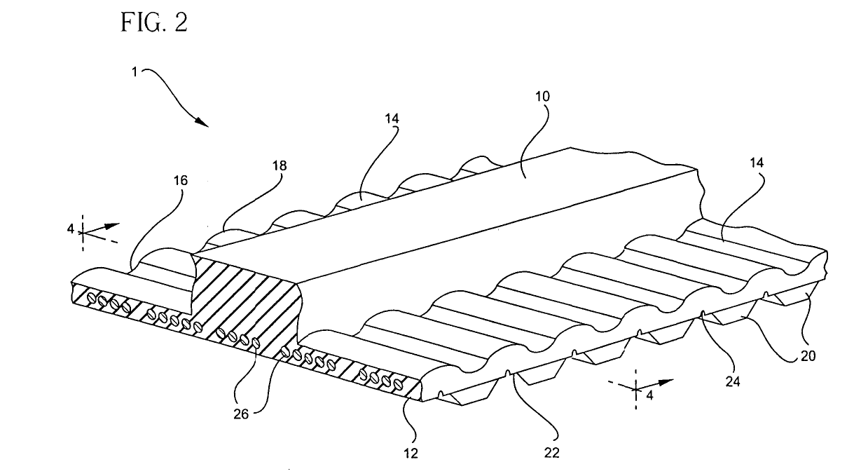

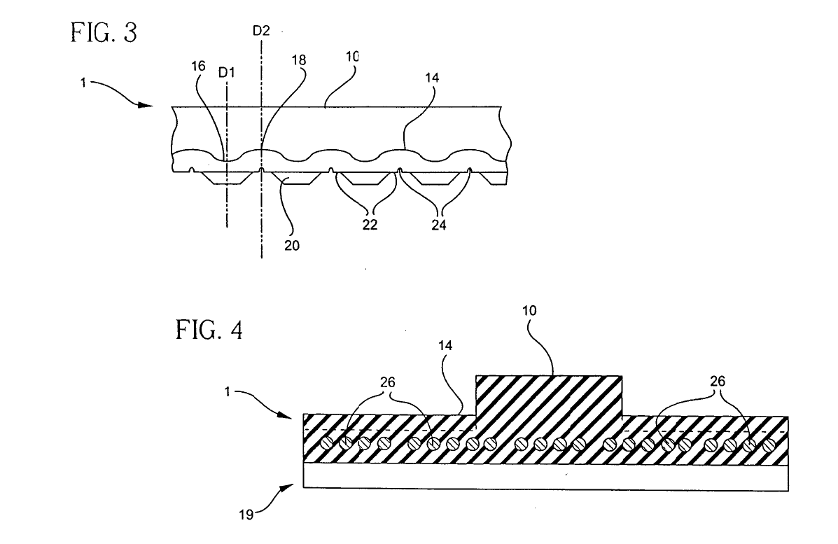

Located on adjacent sides of tracking guide 10 is wave glide surface 14. The material used to form wave glide surface 14 similarly is first formed with the belt in a belt manufacturing process. However, wave glide surface 14 is given its distinctive shape by machining the material as for example with a stylus or cutting jig. Specifically, wave glide surface 14 has a sinusoidal shape when looking at the wave glide surface along a cross-section having a longitudinal axis parallel to the longitudinal axis of the belt, as best can be seen in FIGS. 2 and 3. Wave glide surface 14 includes a maximum height at a plurality of apexes 16 along the sinusoidal curve and a minimum height at a plurality of bases 18 along the sinusoidal curve. When measuring the height of the sinusoidal curve, reference is taken from belt body 12 wherein the belt body underlies the wave glide surface, specifically with reference to the lower portion of the belt underlying pulleys 2 and 2′ in FIG. 1. During operation of the belt, wave glide surface 14 does not come in contact with pulleys 2 and 2′, rather wave glide surface 14 rotates about axises adjacent to the pulleys.

As illustrated in FIGS. 1-4, a first embodiment of the present invention may include teeth 19 having a plurality of tooth ribs 20 and plurality of tooth grooves 22 adjacent to one another. As shown in FIG. 1, tooth ribs 20 extend downward from belt-body 12. Tooth ribs 20 and tooth grooves 22 may extend the entire length of the belt when viewed along a cross-sectional line perpendicular to the longitudinal axis of the belt. Tooth grooves 22 may include slots 24 extending upward towards belt body 12 from a central location of tooth groove 22. Slot 24 improves the flexibility of the belt as the belt is bent and rotated about a belt drive system. Tooth ribs 20 and tooth grooves 22 may be used as either a mechanism for preventing product from displacing itself as a conveyor is rotated or in the situation where belt 1 is used to propel a vehicle along the ground, the teeth may provide contact points between the ground and the belt. Additionally, the teeth may be divided into numerous rows across a surface of the belt.

With reference to FIG. 4, belt 1 may further include an inextensible reinforcing insert 26 that is embedded in the belt body 12.

In a most preferred embodiment of the first embodiment of the invention as shown in FIGS. 1 and 3, bases 18 of the wave glide surface 14 overlay the central portion of tooth ribs 20. Additionally, the apexes 16 of the wave glide surface 14 overlay a central portion of the tooth grooves 22. Consequently, the difference between the lengths of d₁ and d₂ is minimized and provide a somewhat constant thickness from the wave glide surface to the teeth.

During operation of belt 1, wave glide surface 14 remains in contact with slider bed 15. Though shown as being in contact with only a portion of the wave glide surface 14 at any given time, slider bed 15 may be extended so as to remain in contact with wave glide surface 14 entirely or any portion thereof. Slider bed 15 provides structure and support to wave glide surface 14. As for example, in an application wherein belt 1 is used to propel a vehicle forward, slider bed 15 provides a reactionary force to wave glide surface 14 as the belt contacts the ground. Slider bed 15 is shown in FIG. 1, overlaying wave glide surface 14 and providing such support. Since wave glide surface 14 has a cross-sectional longitudinal shape substantially equal to a sinusoidal curve, only apexes 16 of wave glide surface 14 contact the slider bed. This reduces the coefficient of friction between the slider bed and the wave glide surface and thus the belt.

With the coefficient of friction reduced, less torque may be applied to the belt drive system shown in FIG. 1 in order to achieve rotational motion of the belt between pulleys 2 and 2′ and still propel a vehicle forward or move product across a conveyor. In other words, energy inputted into the system is used with greater efficiency so as to be able to increase the energy outputted by the system. Additionally, the curvature of the sinusoidal curves of the wave glide surface 14 may be adjusted in order to increase or decrease the coefficient of friction between wave glide surface 14 and slider bed 15 until an optimum coefficient of friction is achieved. This result is due to the fact that the greater the number of apexes 16, included with wave glide surface 14, the greater number of contact points between the wave glide surface and the slider bed. Specifically, as the number of contact points between the two increases, so does the coefficient of friction between the two. This is contrasted with a belt with a wave glide surface 14 having a reduced number of apexes 16 contacting slider bed 15. With a reduced number of apexes 16, the coefficient of friction is also reduced because of the reduction in contact points between the wave glide surface and the slider bed. However, the number of apexes 16 included with the wave glide surface 14 must be of a sufficient amount that the wave glide surface 14 remains substantially parallel to the slider bed at the contact points. In other words, belt body 12 must remain substantially parallel to slider bed 15, at least at a location substantially between pulleys 2 and 2′.

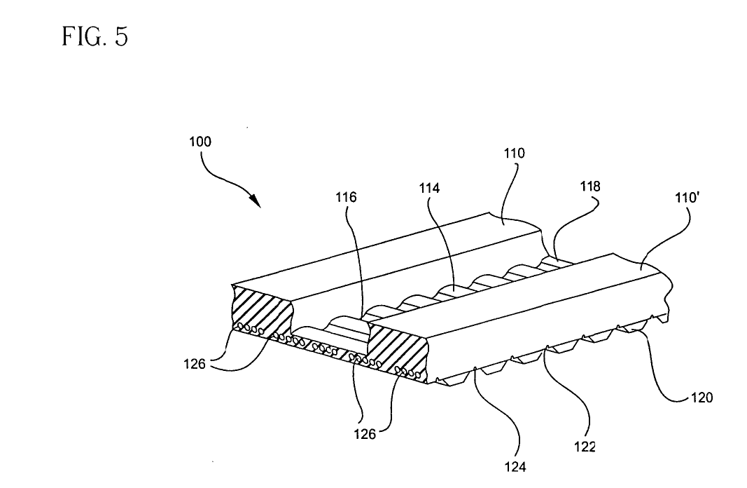

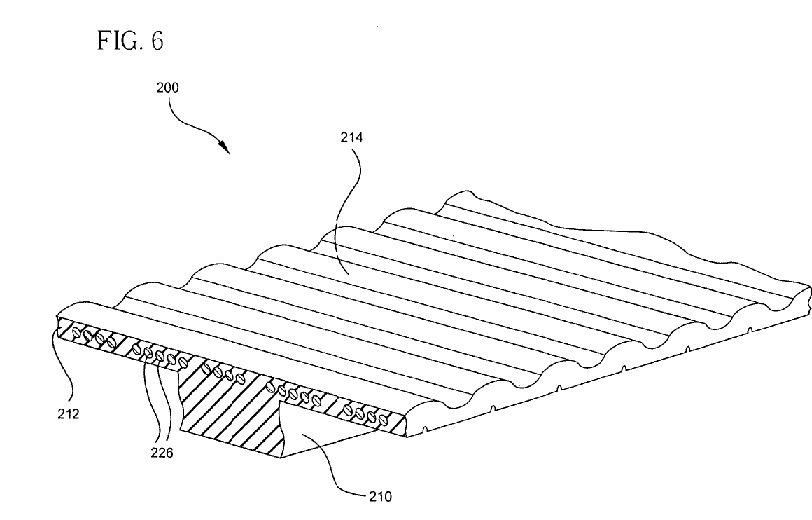

With reference to FIG. 5, a second embodiment of the present invention is illustrated. In the second embodiment of the present invention, two tracking guides 110 and 110′ are provided at the lateral ends of the belt 100. Wave glide surface 114 is provided along a longitudinal line that extends along the center of the belt and is bordered by the tracking guides. As previously discussed, with reference to the first embodiment, wave glide surface 114 includes a shape similar to a sinusoidal curve and includes a plurality of apexes 116 and bases 118. Teeth 119 comprised of a plurality of tooth ribs 120 and tooth grooves 122, adjacent to one another may be provided extending downward from belt body 112. As with the first embodiment, tooth ribs 120 and tooth grooves 122 may extend the entire length of the belt perpendicular to the longitudinal axis of the belt.

In a most preferred embodiment of the second embodiment as with the first embodiment, apexes 116 of the wave glide surface 114 overlay the central portion of tooth grooves 122 while bases 118 of the wave glide surface 114 overlay a central portion of tooth ribs 120. The number of apexes 116, bases 118 and teeth 119 may vary in order to achieve a required coefficient of friction between the belt and a slider bed (not shown). Belt 100 may further include an inextensible reinforcing insert 126 that is embedded in belt body 112.

Belt 1 and belt 100 are substantially alike and may include similar features except for the fact that tracking guide 10 and wave glide system 14 have been transposed in the second embodiment so that the tracking guide perimeters the wave glide surface along the sides of the belt.

Another alternate embodiment is illustrated in FIG. 6. Belt 200 is similar to the first two embodiments and may be designed to cooperate with a slider bed and a tracking guide during its operation. Additionally, belt 200 may include any or all of the previous features previously mentioned in conjunction with belts 1 and 100. However, belt 200 differs from the previous embodiments in that tracking guide 210 is located on an opposing surface of belt body 212 with regard to wave glide surface 214. Wave glide surface 214 still may have a sinusoidal curve cross-sectional shape consisting of a plurality of apexes and bases. During operation of belt 200, the tracking guide may be conveniently located below belt 200 whereas the slider bed is placed on top of wave glide surface 214. Once again, the terms such as top, bottom, overlay and underlay are only used to designate positions of features relative to one another and have no gravitational reference, especially, since as the belt is rotating, the top side and bottom side of the belt are alternating. Though not shown in the figure, belt 200 may include a plurality of teeth either located on the bottom surface of belt body 212 or the teeth may replace a portion of the wave glide surface 214 along longitudinal axis of the belt. As with all embodiments on the present application, belt 200 may further include an inextensible reinforcing insert 226 that is embedded in the belt body 212. Tracking guide 210 may also be eliminated from belt 200 in a situation where a tracking guide is not needed during operation of the belt. A plurality of teeth may replace the tracking guide on the bottom surface of the belt or be included on tracking guide 210.

In other alternate embodiments of the present invention not shown in the drawings, all the embodiments may be constructed wherein the height of the tracking guide is equal to, greater than or even less than the maximum height of the wave glide surface. Alternate embodiments of the present application may be contemplated without deviating from the scope of the invention such as, but not limited to, embodiments where tracking guides may be included on both sides of the belt body. Additionally, a plurality of teeth may also be included on both sides of the belt body, as well as the belt may include more than one row of teeth along the longitudinal axis of the belt. Still even more modifications may be made such as having teeth which cooperate with a tooth pulley system so as to minimize any chance of the belt laterally moving off its axis between a pulley system. Such teeth may be included in addition to a tracking guide, may replace a tracking guide or may even be formed with a tracking guide.

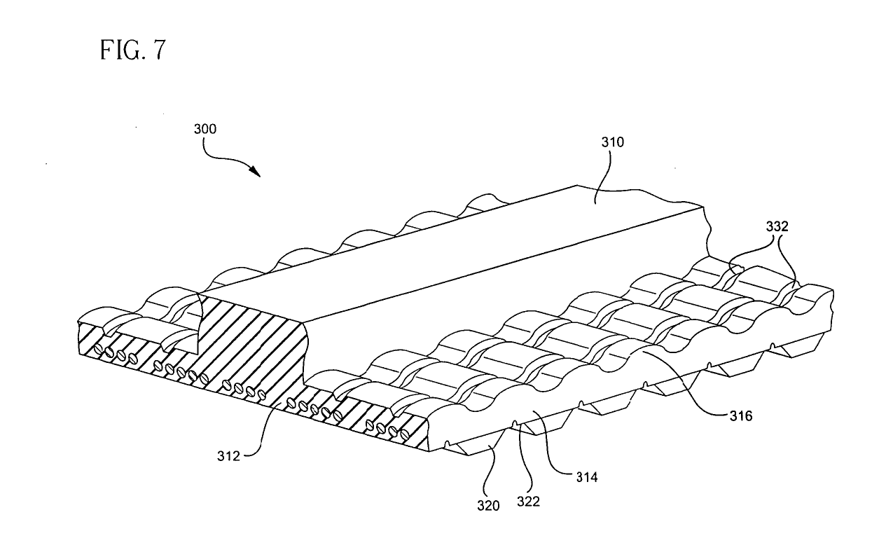

In still a further embodiment, as illustrated in FIG. 7, the wave glide surface of the belt may include channels for an agent. Specifically, belt 300 is similarly designed to belt 1 having wave glide surface 314, tracking guide 310, belt body 312 and a plurality of teeth comprised of tooth ribs 320 and tooth grooves 322 adjacent to one another.

The essential distinction between belt 300 and belt 1 is channels 332 are disposed on wave glide surface 314. During the operational use of belt 300, the agent located in channels 332 is capable of coating substantially the entire wave glide surface 314 and more specifically, apexes of the wave glide surface 314 as well as the slider bed. The channels may be disposed on a belt not having a wave glide surface as well.

Channels 332, though shown as having a trapezoids configuration , may have any geometric shape. Additionally, channels 332 may have a depth of varying height so long as channels 332 do not extend completely downward either through the belt body 312 or through tooth ribs 320. In a preferred embodiment, the bottoms of channels 332 remain substantially parallel to the belt body 312 throughout the belt, i.e., when the belt is flat. The sides of channels 332 may be sloped so as to facilitate dispersion of the agent across the wave glide surface. As apexes 316 of wave glide surface 314 come in contact with a slider bed as previously discussed, the agent may further either increase or decrease the coefficient of friction between the two depending on the composition and properties of the agent used. Thus, when a lubricating agent which decreases the coefficient of friction between the slider bed and belt is used, less torque may be applied to the belt drive system utilizing belt 300 in order to rotate the belt. Alternatively, when a agent which increases the coefficient of friction is used, a reduced breaking force is required to bring the belt to a stopped position. Channels 332 may be distributed along a longitudinal axis of belt 300 along wave glide surface 314 or additionally channels 332 may follow a more patterned design.

Additionally, channels 332 may have a spiral or sinusoidal shape when looking at the belt from a top view. Channels 332 aid the movement of the agent located along the surface of the wave glide surface 314 and slider bed.

Although the channels have been described herewith with reference to belt 300, which is similar to belt 1, the channel system as described herein may be included in any of the embodiments described herein.

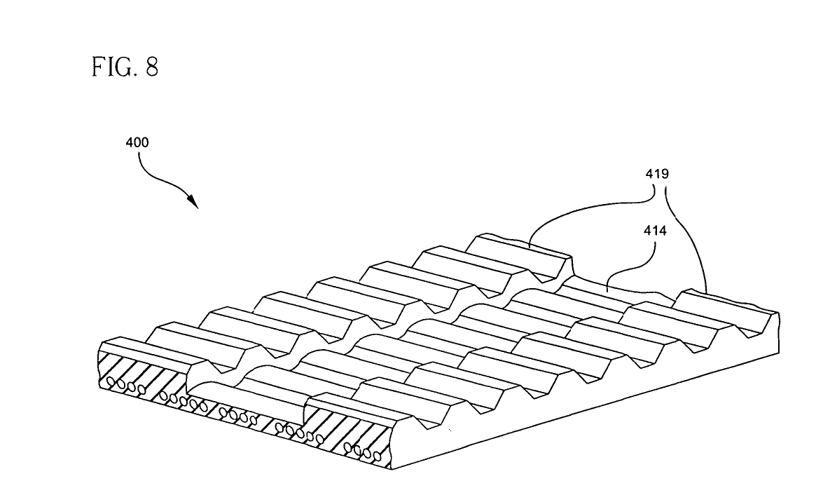

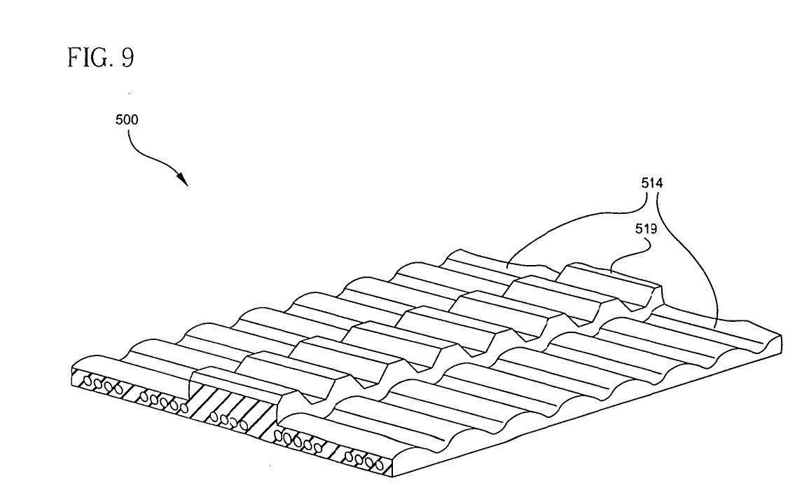

Additional embodiments, such as those shown in FIGS. 8 and 9 may include some or all of the features previously mentioned. FIG. 8 includes wave glide surface 414 bordered by teeth 419. Wave glide surface 414 and teeth 419, as previously described, are shown disposed on the same surface of belt 400.

FIG. 9 shows wave glide surface 514 on both sides of teeth 519; as also previously mentioned, both features are disposed on the same side of belt 500.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A timing belt comprising:
a wave glide surface extending in a longitudinal direction of said belt, said wave glide surface having an apex portion and a base portion.

2. A timing belt according to claim 1, wherein said belt includes teeth, said teeth having a plurality of tooth ribs and tooth grooves.

3. A timing belt according to claim 2, wherein said teeth extend the entire side-to-side lateral length of said belt.

4. A timing belt according to claim 2, wherein said teeth of said belt are located on an opposite surface of the belt as compared with said wave glide surface.

5. A timing belt according to claim 2, wherein said apex portion of said wave glide surface is adjacent to said grooves of said teeth.

6. A timing belt according to claim 2, wherein the belt includes a slot and a belt body, said slot being located within said belt body adjacent to said tooth grooves.

7. A timing belt according to claim 1, further comprising at least one channel, said channel being provided on said wave glide surface.

8. A timing belt according to claim 2, further comprising at least one channel, said channel being provided on said wave glide surface.

9. A timing belt according to claim 7, wherein said channel also extends along a longitudinal direction of said belt.

10. A timing belt according to claim 7, wherein said channel has a geometric curve on said wave glide surface.

11. A timing belt comprising:
a tracking guide that extends in a longitudinal direction of said belt; and
a wave glide surface also extending in a longitudinal direction of said belt, said wave glide surface having an apex portion and a base portion.

12. A timing belt according to claim 11, wherein said tracking guide has a height that is greater than the height of said apex of said wave glide surface.

13. A timing belt according to claim 1, wherein said belt includes teeth, said teeth having a plurality of tooth ribs and tooth grooves.

14. A timing belt according to claim 13, wherein said teeth of said belt are located on an opposite surface of the belt as compared with said wave glide surface.

15. A timing belt according to claim 13, wherein said apex portion of said wave glide surface is adjacent to said grooves of said teeth.

16. A timing belt according to claim 11, further comprising at least one channel, said channel being provided on said wave glide surface.

17. A timing belt according to claim 13, further comprising at least one channel, said channel being provided on said wave glide surface.

18. A timing belt according to claim 11, wherein said tracking guide is adjacent to said wave glide surface.

19. A timing belt according to claim 16, wherein said channels have sloped sides.

20. A timing belt according to claim 16, wherein said channels have a geometric curve.

21. A timing belt according to claim 20, wherein said geometric curve is substantial a sinusoidal curve.

22. A timing belt according to claim 20, wherein said geometric curve is a spiral curve.

23. A timing belt comprising:
a wave glide surface extending in a longitudinal direction of said belt, said wave glide surface having an apex portion and a base portion;
a tracking guide that also extends in a longitudinal direction of said belt;
a plurality of teeth, said teeth having a plurality of tooth ribs and tooth grooves; and
at least one channel, said channel being disposed within a surface of said wave glide surface for holding and dispersing an agent.

24. A timing belt according to claim 23, wherein said teeth extend the entire side-to-side of said lateral lanes of said belt.

25. A timing belt according to claim 23, wherein said teeth of said belt are located on opposite sides of the belt as compared with said wave glide surface.

26. A timing belt according to claim 23, wherein said apex portion of said wave glide surface is adjacent to said grooves of said teeth.

27. A timing belt according to claim 23 wherein the belt includes a slot and a belt body, said slot being located with in said belt body adjacent to said tooth grooves.

28. A timing belt according to claim 23, wherein at least one channel is provided on said wave glide surface.

29. A timing belt assembly comprising:
a belt; and
a slider bed, said slider bed having a cross-sectional sinusoidal surface, said sinusoidal surface coming in contact with said belt.

30. A timing belt assembly according to claim 29, further comprising a tracking guide.

31. A timing belt assembly according to claim 29, further comprising a channel for housing and dispersing an agent, said channel being disposed on said belt.

32. A timing belt assembly according to claim 29, further comprising a channel, said channel being disposed on said slider bed.

33. The timing belt assembly according to claim 29, further comprising teeth.

34. A timing belt comprising:
a slider bed;
a belt extending in a longitudinal direction and having at least two surfaces remote from one in another, wherein one of said surfaces is adapted for making contact with said surfaces; and
at least one channel disposed on and extending along said contacting surface of said belt in a longitudinal direction, said channel adapted for housing and dispersing an agent.
